(19) United States
(12) Patent Application Publication
(10) Pub. No.: US 2020/0059606 A1
(43) Pub. Date: Feb. 20, 2020

(54) Multi-Camera System for Tracking One or More Objects Through a Scene

(71) Applicant: Aqueti Incorporated, Durham, NC (US)

(72) Inventor: David Jones Brady, Durham, NC (US)

(21) Appl. No.: 16/487,325

(22) PCT Filed: Mar. 2, 2018
(86) PCT No.: PCT/US2018/020695

§ 371 Date: Aug. 20, 2019

Related U.S. Application Data
(60) Provisional application No. 62/466,899, filed on Mar. 3, 2017.

(51) Int. Cl. H04N 5/247; H04N 7/18

(52) U.S. Cl. CPC H04N 5/247; H04N 7/18

(57) ABSTRACT

An imaging system for monitoring an observation region is disclosed, wherein the imaging system comprises a plurality of cameras having diverse focal lengths, where the plurality of cameras is arranged such that they can collectively observe any point in the observation region with the same ground sample distance. In some embodiments, each of the cameras has a different angular field of view. In some embodiments, the cameras are arranged such that each monitors a different region within the observation region, and such that the chief ray of each camera passes through the center of the region it monitors. In some embodiments, the plurality of cameras are arranged in two groups, one on each side of the observation region. In some embodiments, the plurality of cameras is mounted on a movable platform that traverses the observation region.

### CROSS REFERENCE TO RELATED APPLICATIONS

This application claims the benefit of U.S. Provisional Patent Application Ser. No. 62/462,204, filed Feb. 22, 2017, entitled “ Modular Medicine Case for Improved Regimen Compliance,” (Attorney Docket: 3005-006PR1), which is incorporated herein by reference.

In addition, the following documents are also incorporated herein by reference:
U.S. Pat. No. 8,861,089;
https://facebook360.fb.com/facebook-surround-360/;
US Patent Publication No. 20170031138;
Canadian Patent No. CA2805079C;
Cull, et al., “Three dimensional imaging with the argus sensor array,” Proc. SPIE, Three-Dimensional TV, Video, and Display, Vol. 4864, pp. 211-222 (2002); and
Marks, et al., “Cone-beam tomography with a digital camera,” Applied optics, 40(11), 1795-1805 (2001).

If there are any contradictions or inconsistencies in language between this application and any document that has been incorporated by reference that might affect the interpretation of the claims in this case, the claims in this case should be interpreted to be consistent with the language in this case.

### TECHNICAL FIELD

The present disclosure relates to optics in general, and, more particularly, to array cameras for imaging, tracking, and identifying one or more objects travelling through a scene.

### BACKGROUND

There are many situations in which it is desirable to track vehicles, people, and/or objects as they travel through a scene, such as a corridor (e.g., a hallway a road, etc.). Historically, pan-tilt-zoom (PTZ) cameras were commonly used to track such objects, wherein the camera used a pan-tilt system to track the object's motion down the corridor, adjusting optical focus and zoom to keep the moving object in focus and to keep the scale of the object on the image sensor approximately constant as the object transited the corridor.

Unfortunately, such PTZ systems are mechanical and, therefore, subject to fatigue and failure over time. In addition, physical motion of the camera is often detectable by the object, which can be undesirable in situations in which stealth observation is warranted. Furthermore, PTZ systems can track only one object at any given time.

The development of array-camera systems enabled imaging of scenes larger than the field of view of a single camera without some of the drawbacks of PTZ camera systems. Over the years, array cameras have found use in diverse applications including, among others, panoramic imaging, extremely high pixel-count imaging, digital super-resolution imaging, variable-resolution imaging, and mobile-phone cameras.

More recently, array-cameras have been directed toward monitoring and tracking an object transiting through a scene, such as systems disclosed in Canadian Patent Application CA2805079. Using such a system, a large-area scene is monitored in real time with little distortion using a plurality of cameras, each of which includes a plurality of image sensors. The image sensors are provided randomly sized solid angles for surveillance, which enables each image sensor to scan a different area of the scene. In other words, each image sensor has a different angular field of view such that different parts of the scene are imaged at different ranges with respect to the camera array. Unfortunately, the complexity of such prior-art surveillance systems leads to significant cost, as well as data networking issues that must be addressed to enable composite images of the scene to be developed.

The need for a highly reliable system capable of simultaneously tracking multiple objects remains, as yet, unmet in the prior art.

### SUMMARY

The present invention enables capture of video sequences analogous to those obtained via PTZ systems for one or more objects transiting a corridor without requiring mechanical motion of the imaging system. Embodiments of the present invention employ an array-camera system to sample points in the state-space of its cameras as they track one or more objects along a corridor. Embodiments of the present invention are well suited for use in applications such as fixed surveillance systems, mobile surveillance systems, stealth surveillance systems, object tracking systems, autonomous vehicle guidance, and the like.

An illustrative embodiment of the present invention includes an array of cameras that is arranged to observe a plurality of regions along a corridor, where the cameras of the array have diverse focal lengths and the chief ray of each camera is set to pass through the center of the region observed by that camera.

In some embodiments, complimentary arrays of cameras are arranged on both sides of the corridor, thereby enabling collection of a complete set of perspectives of the object or objects.

In some embodiments, an array camera is mounted on a movable vehicle that is moved along a path relative to the corridor to capture an image of the corridor. Moving vehicles suitable for use in such embodiments include, without limitation autonomous vehicles, unmanned vehicles, manned vehicles, unmanned aerial vehicles (UAV) (e.g., drones, etc.), and the like.

An embodiment of the present invention is an imaging system for monitoring an observation region, the imaging system comprising a first plurality of cameras, wherein each camera of the first plurality thereof has a different focal length, and wherein the first plurality of cameras is arranged such that it can observe any point in the observation region with a first ground sample distance (GSD).

Another embodiment of the present invention is a method for monitoring an observation region, the method comprising: providing a first plurality of cameras, wherein each camera of the first plurality thereof has a different focal length; and arranging the first plurality of cameras such that it can observe any point in the observation region with a first ground sample distance (GSD).

### BRIEF DESCRIPTION OF THE DRAWINAS

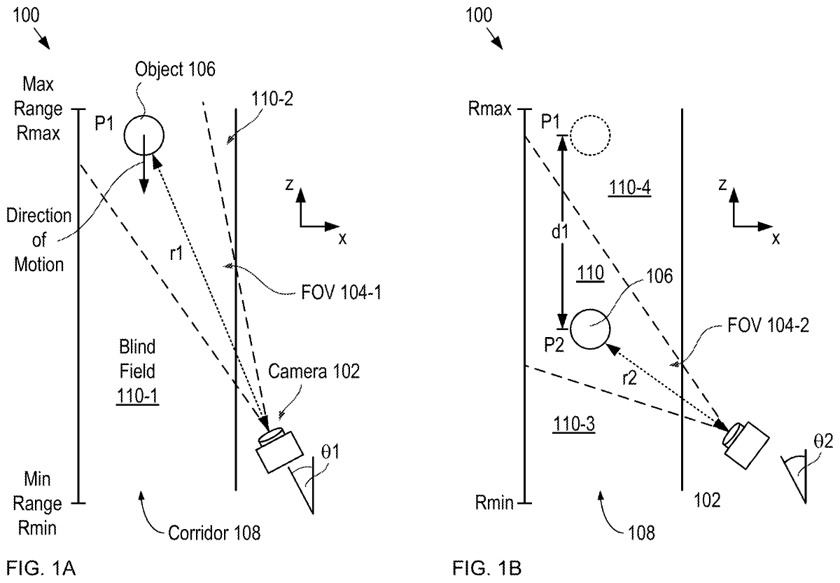

FIGS. 1A-B depict schematic drawings of a prior-art imaging system for tracking an object through an observation region, before and after, respectively, the object has moved between two positions in the corridor.

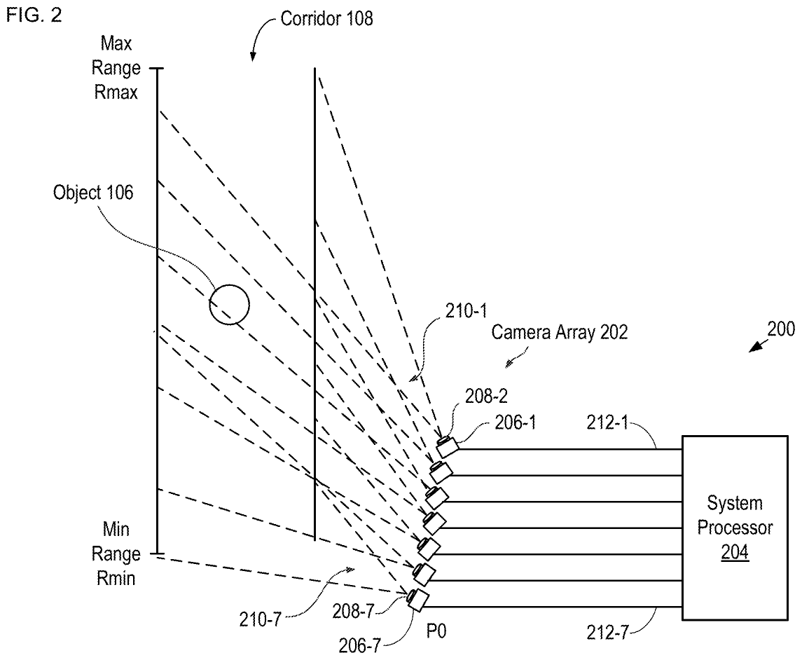

FIG. 2 depicts a schematic drawing of an imaging system suitable for tracking one or more objects as they transit an observation region in accordance with an illustrative embodiments in accordance with the present disclosure.

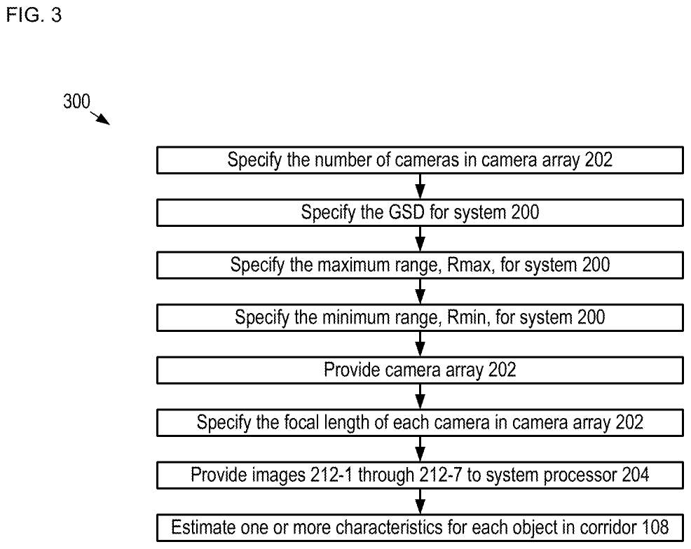

FIG. 3 depicts operations of a method suitable for detecting and tracking one or more objects in an observation region in accordance with the illustrative embodiment.

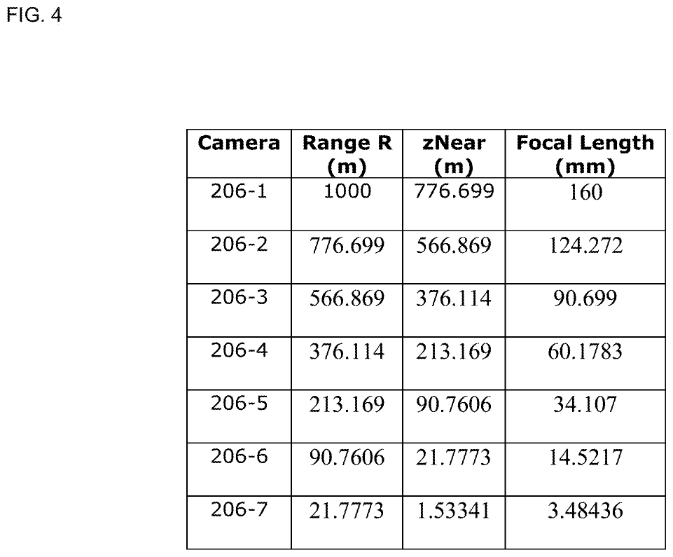

FIG. 4 shows a table of focal lengths for the prime lenses of a seven-camera imaging system able to track one or more objects through the entire range of a corridor in accordance with the illustrative embodiment.

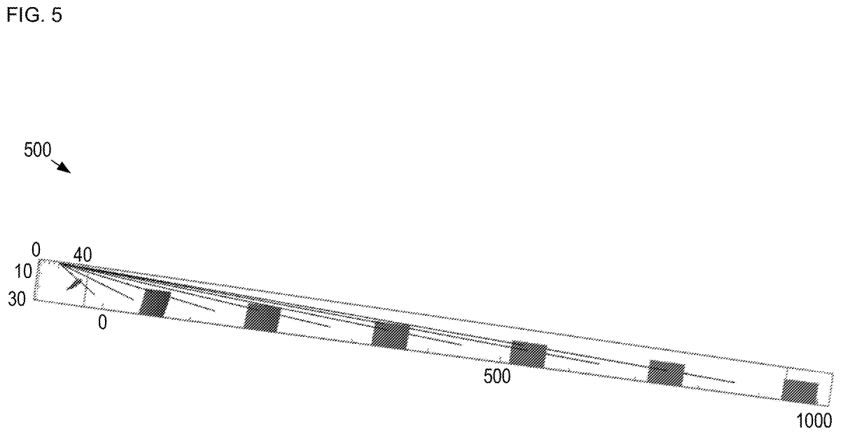

FIG. 5 depicts an estimation of the chief rays for system 200. It should be noted that the orientation of object 106 with respect to the chief ray of each camera changes as the object travels through the corridor.

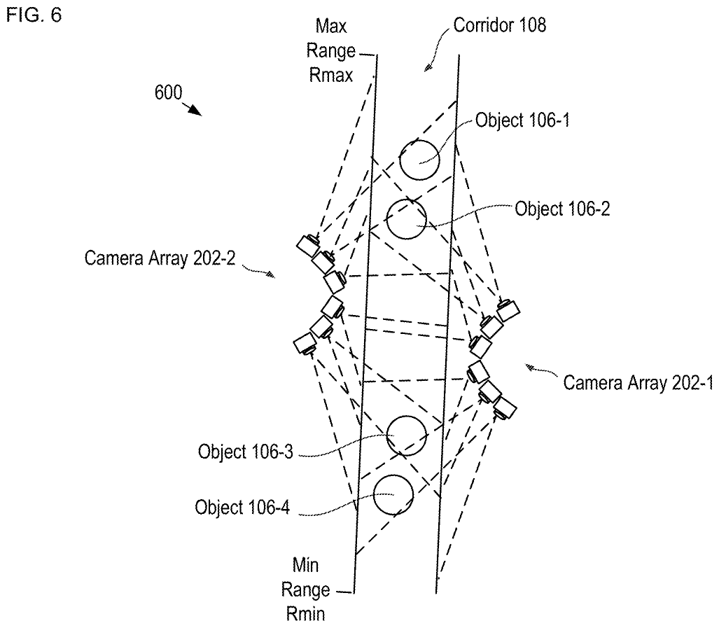

FIG. 6 depicts a schematic drawing of an imaging system suitable for tracking one or more objects as they transit an observation region in accordance with an alternative embodiment in accordance with the present disclosure.

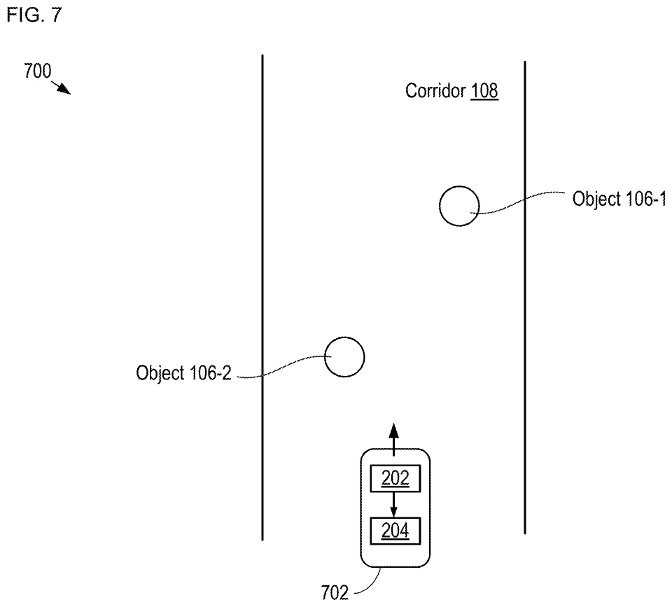

FIG. 7 depicts a schematic drawing of an imaging system suitable for observing a stationary corridor in accordance with embodiment in accordance with the present disclosure.

### DETAILED DESCRIPTION

FIGS. 1A-B depict schematic drawings of a prior-art imaging system for tracking an object through an observation region, before and after, respectively, the object has moved between two positions in the corridor. Imaging system 100 includes camera 102, which is configured to maintain observation of object 106 as it travels the length of corridor 108. For simplicity, the operation of system 100 is depicted in only two-dimensions.

Imaging system 100 is designed to enable sufficient resolution for performing facial recognition on any person located at any point within an observable range in corridor 108, where the observable range covers the full width of the corridor from minimum range Rmin to maximum range Rmax along its length (i.e., along the z-direction). Facial recognition typically requires a ground sample distance (GSD) of approximately 2-5 mm on the face of a person anywhere within observed space. For the purposes of this Specification, including the appended claims, the term “ground sample distance (GSD)” is defined as the minimum-resolved feature of an imaging system.

GSD is related to the focal length, F, of camera 102 and the pixel pitch, p, of its imaging sensor according to:

$$G S D = z \frac{p}{F} ,$$

where z is the range of the object relative to the camera (i.e., the straight-line distance between camera 102 and object 106).

Camera 102 is a conventional PTZ camera located at a fixed point in space relative to corridor 108 such that its field of view (FOV) 104 can be swept over the entire desired observation area of the corridor.

When object 106 is at position P1 (FIG. 1A), camera 102 is oriented at angle θ1 relative to the z-axis such that the object is centered in its field of view. In addition, camera 102 is zoomed in to achieve the required GDS on the object. As a result, camera 102 is characterized by FOV 104-1. Because object 106 is near the far end of the observable range within corridor 108, the required zoom level necessary to achieve the required GDS results in FOV 104-1 being narrow. It should be noted that the regions of the corridor outside FOV 104-1 cannot be observed by camera 102. These are denoted as blind fields 110-1 and 110-2.

When object 106 moves down corridor 108 by distance d1 to position P2 (FIG. 1B) the orientation of camera 102 physically adjusts (i.e., the camera is panned and tilted) to maintain observation of the object and keep the object at the center of its field of view. In addition, camera 102 is zoomed out so that GSD remains constant. As a result, when object 106 is located at position P2, camera 102 is re-oriented to angle θ2 and its field of view changes from relatively narrower FOV 104-1 to relatively wider FOV 104-2. When oriented at angle θ2 with FOV 104-2, camera 102 is unable to observe any other object that might be simultaneously located in blind fields 112-3 and 112-4. As a result, system 100 can track only one object at any given time.

It is an aspect of the present invention that, in contrast to the prior art, array cameras that include an array of cameras having multiple-focal-length prime lenses enable simultaneous tracking of multiple objects within its observable region.

FIG. 2 depicts a schematic drawing of an imaging system suitable for tracking one or more objects as they transit an observation region in accordance with an illustrative embodiments in accordance with the present disclosure. System 200 includes camera array 202 and processor 204. System 200 is a multi-camera surveillance system for simultaneously tracking one or more vehicles traversing corridor 108 without requiring mechanical motion of any camera in the array. In the depicted example, corridor 108 is 40-meters wide and 20-meters tall.

FIG. 3 depicts operations of a method suitable for detecting and tracking one or more objects in an observation region in accordance with the illustrative embodiment. Method 300 begins with operation 301, wherein the number of cameras, N, in camera array 202 is specified. In the depicted example, N=7 (i.e., camera array 202 includes seven cameras); however, any practical plurality of cameras can be used in camera array 202 without departing from the scope of the present disclosure. For the purposes of the present disclosure and the specification of the arrangement of system 200, cameras 206-1 through 206-7 (referred to, collectively, as cameras 206) are considered to be co-located at positon P0; however, in some embodiments, the differences in the positions of cameras 206 is significant and must be considered when specifying the design parameters of elements of an imaging system in accordance with the present disclosure.

At operation 302, a desired GSD for system 200 is specified. In the depicted example, imaging system 200 is intended to track one or more vehicles passing through corridor 108. As a result, the desired GSD for system 200 can be relatively large and, in this example, is specified as 1 cm. It should be noted that GSD for an imaging system is typically based on the application for which the imaging system is intended. As a result, the desired GSD for system 200 can be selected as any value within a wide range depending upon the type of object (e.g., person, vehicle, aircraft, projectile, etc.) intended to be tracked through its observation region.

At operation 303, the maximum range, Rmax, at which an object is to be tracked is specified. In the depicted example, F_{max is} 1000 m; however, any practical value for Rmax can be used without departing from the scope of the present disclosure.

At operation 304, the minimum range, Rmin, at which an object is to be tracked is specified. In the depicted example, Rmin is approximately 1.5 m; however, any practical value for Rmin can be used without departing from the scope of the present disclosure.

At operation 305, camera array 202 is provided. In the depicted example, camera array 202 is located 10 meters above and 10 meters to the side of corridor 108 at position P0.

Cameras 206 are configured such that system 200 has a substantially constant GSD and focus is substantially maintained at all points along corridor 108. Each of cameras 206-i, where i=1 through 7, includes prime lens 208-i and is characterized by FOV 210-i. In the depicted example, each of cameras 206 includes a high-pixel-count focal-plane array having pixel pitch, p, equal to 1.6 microns.

At operation 306, the focal length of each of prime lenses 208-1 through 208-7 is specified.

Objects are in focus for each of cameras 206 when the imaging law is satisfied for that camera. The imaging law for camera 206-i can be expressed as:

$$\frac{1}{{z}_{o}} + \frac{1}{{z}_{i}} = \frac{1}{F}$$

where z₀ is the distance from camera 206-i to object 106 and zᵢ is distance from the exit pupil of the lens of camera 206-i to the image.

The depth of field of the imaging system is the range over which this law is substantially satisfied, which occurs when:

$$\vert \frac{1}{{z}_{o}} + \frac{1}{{z}_{i}} - \frac{1}{F} \vert < \frac{1}{{z}_{h}}$$

where zₙ is the distance between the camera lens and the closest object that is in focus when the camera lens is focused at infinity (i.e., the hyperfocal distance).

Given that the maximum distance for observation in the corridor is Rmax, for pixel pitch, p, the focal length lens required for prime lens 208-1 is Fₘₐₓ=p Rmax/GSD, which ensures that object 106 is sampled with the desired GSD at the maximum range of camera 206-1, whose FOV 210-1 includes Rmax.

The hyperfocal distance for prime lens 208-7, therefore, is zₕ=Fₘₐₓ²/p(f/#), where f/# is the f/# of the lens. Setting such that:

$$\frac{1}{{R}_{max}} + \frac{1}{{z}_{i}} - \frac{1}{{F}_{max}} = - \frac{1}{{z}_{h}}$$

enables solving for the near focal point of lens 208-1.

Taking the near focal point for prime lens 208-i as the long focal point of prime lens 208-(i+1), a set of focal lengths that will keep the object approximately in focus for the entire length of corridor 108 can be determined. In the depicted example, using an f-number of f/2.3, the focal lengths for each of prime lenses 208-1 through 208-7 (referred to, collectively, as prime lenses 208 ) can be determined.

FIG. 4 shows a table of focal lengths for the prime lenses of a seven-camera imaging system able to track one or more objects through the entire range of a corridor in accordance with the illustrative embodiment. It should be noted that the focal lengths included in FIG. 4 enable an imaging system whose fields-of-view substantially abut one another with minimal overlap. In some embodiments, it is preferable that prime lenses 208 are designed such that the fields-of-view of adjacent cameras overlap one another by as much as a few percent.

In some embodiments, it is preferable that the chief ray of each camera passes through the center of the region of corridor observed by that camera.

FIG. 5 depicts an estimation of the chief rays for system 200. It should be noted that the orientation of object 106 with respect to the chief ray of each camera changes as the object travels through the corridor.

At operation 307, cameras 206-1 through 206-7 provide images 212-1 through 212-7, respectively, to processor 204.

Processor 204 comprises conventional processing circuitry, control circuitry, memory, and the like, and is configured to, among other things, execute software functions, store and retrieve data from memory (normally included in processor 204), reconstruct corridor 108 based on images 212-1 through 212-2 and generate an estimate of one or more characteristics for objects within the corridor. In the depicted example, processor 204 is implemented as a single, discrete processing unit within system 200. In various other embodiments, the processing circuit can be distributed, at least in part, among multiple components of system 200, implemented, in part or in full, in a remote or cloud-based computing system, or otherwise implemented in a suitable arrangement for carrying out the functions described herein.

At operation 308, processor 204 estimate one or more characteristics for one or more objects traversing corridor 108 based on images 212-1 through 212-7. The object characteristics estimated by processor 204 include, without limitation:

i. object classification; or

ii. object identity; or

iii. speed; or

iv. trajectory; or

v. acceleration; or

vi. size; or

vii. any combination of i, ii, iii, iv, v, and vi.

FIG. 6 depicts a schematic drawing of an imaging system suitable for tracking one or more objects as they transit an observation region in accordance with an alternative embodiment in accordance with the present disclosure. System 600 includes a pair of complementary camera arrays, which are located on either side of corridor 108. System 600 enables collection of a complete set of perspectives for one or more objects transiting corridor 108.

Since the perspectives all have approximately the same GSD (with digital zoom used within the range of a single camera to keep GSD constant), the set of images collected and provided to processor 204 as the object transits the corridor can be reordered to be effectively equivalent to observing the object with a ring of cameras, such as those discussed by Marks, et al., in “Cone-beam tomography with a digital camera,” Applied optics, 40(11), 1795-1805 (2001). System 600, therefore, is operative for producing images that can be used to reconstruct the observed object in three dimensions.

Preferably, object 106 is observed at substantially equal angular spacing, which facilitates three-dimensional (3D) reconstruction. The rate of change in angular perspective on the object as the object moves along the corridor is:

$$\frac{d θ}{dt} = v \frac{h}{{h}^{2} + {z}^{2}}$$

where v is the velocity of object 106, h is the cross range offset between object 106 and a camera 206, and z is the range to the object along corridor 108.

The angular sampling rate of perspectives on the object is

$$fps / \frac{d θ}{dt} ,$$

where fps is the frame rate of the camera in frames per second. To keep this rate approximately constant as a function of z, fps must increase as z decreases. In practice, it is beneficial for early object recognition to over sample at long ranges (for example setting fps at 10 frames per second) and to sample at critical rates near at close ranges (for example setting fps at 120 frames per second). In some embodiments, therefore, cameras 206 have variable frame rates to facilitate proper data-rate management.

FIG. 7 depicts a schematic drawing of an imaging system suitable for observing a stationary corridor in accordance with embodiment in accordance with the present disclosure. System 700 includes camera array 202, processor 204, and vehicle 702.

Vehicle 702 is a movable platform operative for conveying camera array 202 and processor 204 through corridor 108. In the depicted example, vehicle 702 is a truck; however, any suitable movable platform can be used as vehicle 702, including unmanned aerial vehicles (UAVs), autonomous vehicles (e.g., self-driving cars, trucks, etc.), drones, underwater vehicles, boats, unmanned underwater vehicles (UUVs), and the like.

In operation, vehicle 702 conveys camera array 202 and processor 204 through at least a portion of corridor 108 to uniformly observe the corridor around or to the side of the vehicle. While the vehicle is not able to see both sides of the surrounding corridor, a limited cone of view angles is sufficient to create a 3D model of the surrounding scene.

In some embodiments, repeated trips through corridor 108, such as along a set of linear paths, are used to fully sample views suitable for 3D reconstruction. In addition to 3D reconstruction, because camera array 202 has constant GSD as a function of range, efficient multi-frame analysis of the surrounding objects is enabled. The use of constant GSD and 3D reconstruction is especially useful for modeling the surrounding scene for autonomous vehicles.

It is to be understood that the disclosure teaches just exemplary embodiments and that many variations can easily be devised by those skilled in the art after reading this disclosure and that the scope of the present invention is to be determined by the following claims.

What is claimed is:

1. An imaging system for monitoring an observation region, the imaging system comprising a first plurality of cameras, wherein each camera of the first plurality thereof has a different focal length, and wherein the first plurality of cameras is arranged such that it can observe any point in the observation region with a first ground sample distance (GSD).

2. The imaging system of claim 1 further comprising a processor that is configured to receive a first plurality of images from the first plurality of cameras, wherein each of the first plurality of cameras provides a different image of the first plurality thereof.

3. The imaging system of claim 2 wherein the processor is further configured to reconstruct at least a portion of the observation region based on the first plurality of images.

4. The imaging system of claim 1 wherein first plurality of cameras is arranged such that each camera has a different field of view within the observation region.

5. The imaging system of claim 4 wherein adjacent fields of view of the first plurality of cameras partially overlap one another.

6. The imaging system of claim 1 further comprising a platform that is movable relative to the observation region, wherein the first plurality of cameras is mounted on the platform.

7. The imaging system of claim 1 further comprising a second plurality of cameras, wherein each of the first plurality of cameras and the second plurality of cameras is outside of the observation region, and wherein the observation region is between the first plurality of cameras and the second plurality of cameras, and wherein each camera of the second plurality thereof has a different focal length, and wherein the second plurality of cameras is arranged such that it can observe any point in the observation region with the first (GSD).

8. The imaging system of claim 1 wherein first plurality of cameras is arranged such that each camera has a different field of view within the observation region, and wherein at least two cameras of the first plurality thereof have different angular fields of view.

9. The imaging system of claim 8 wherein each camera of the first plurality thereof has a different angular field of view.

10. A method for monitoring an observation region, the method comprising:
providing a first plurality of cameras, wherein each camera of the first plurality thereof has a different focal length, and wherein each camera of the first plurality thereof has a different field of view within the observation region, and further wherein adjacent fields-of-view of the plurality thereof at least partially overlap; and
arranging the first plurality of cameras such that it can observe any point in the observation region with a first ground sample distance (GSD).

11. The method of claim 10 further comprising:
receiving a plurality of images at a processor, wherein the plurality of cameras generates the plurality of images; and
reconstructing at least a portion of the observation region based on the plurality of images.

12. The method of claim 10 wherein the first plurality of cameras is provided such that at least two cameras have different angular fields of view.

13. The method of claim 10 wherein the first plurality of cameras is provided such that each camera has a different angular field of view.

14. The method claim 10 further comprising locating the first plurality of cameras on a platform that is movable relative to the observation region.

15. The method claim 14 further comprising moving the platform relative to the observation region.

16. The method of claim 10 further comprising:
providing a second plurality of cameras, wherein each camera of the second plurality thereof has a different focal length, and wherein each camera of the second plurality thereof has a different field of view within the observation region, and wherein adjacent fields-of-view of the second plurality thereof at least partially overlap, and further wherein the second plurality of cameras is arranged such that it can observe any point in the observation region with the first (GSD); and
locating each of the first plurality of cameras and second plurality of cameras outside the observation region such that the observation region is between the first plurality of cameras and the second plurality of cameras.
